(19) United States
(12) Patent Application Publication
(10) Pub. No.: US 2013/0156121 A1
(43) Pub. Date: Jun. 20, 2013

(54) INTER-BASE-STATION COOPERATED MIMO TRANSMITTING METHOD AND BASE STATION APPARATUS

(71) Applicants: Tetsushi Abe, Tokyo (JP); Kenichi Higuchi, Tokyo (JP)

(72) Inventors: Tetsushi Abe, Tokyo (JP); Kenichi Higuchi, Tokyo (JP)

(73) Assignee: NTT DOCOMO, INC., Tokyo (JP)

(21) Appl. No.: 13/702,316

(22) PCT Filed: Jun. 6, 2011
(86) PCT No.: PCT/JP2011/062983

§ 371 Date: Mar. 6, 2013

(30) Foreign Application Priority Data
Jun. 9, 2010 (JP) 2010-132353

(51) Int. Cl. H04B 7/04

(52) U.S. Cl. CPC H04B 7/0456
USPC 375/267

(57) ABSTRACT

A decrease in a transmission capacity is suppressed even when CSI is not fed back from a mobile station apparatus to all cooperating base station apparatuses. A base station apparatus (BS2) decides, according to the presence/absence of CSI fed back from a plurality of mobile station apparatuses (MS (MS1, MS2)), a cooperation target mobile station apparatus (MS2) to which the base station apparatus transmits a signal in cooperation with another base station apparatus (BS1) and a non-cooperation target mobile station apparatus (MS1) to which a specific base station apparatus (BS1) transmits a signal, and generates a precoding weight for the signal transmitted to the cooperation target and non-cooperation target mobile station apparatuses (MSs) based on the channel state information.

### TECHNICAL FIELD

The present invention relates to an inter-base-station cooperated MIMO transmitting method for a plurality of base station apparatuses to cooperate with each other to perform MIMO transmission to a plurality of mobile station apparatuses, and such base station apparatuses.

### BACKGROUND ART

UMTS (Universal Mobile Telecommunications System) networks are making the most of the features of a W-CDMA (Wideband Code Division Multiple Access) based system by adopting HSDPA (High Speed Downlink Packet Access) and HSUPA (High Speed Uplink Packet Access) aiming at improving frequency utilization efficiency and improving data rates. For these UMTS networks, Long Term Evolution (LTE) is under study for the purpose of realizing higher data rates and lower delay or the like.

Third-generation systems can generally realize a transmission rate on the order of maximum 2 Mbps on the downlink using a 5-MHz fixed band. On the other hand, LTE systems can realize a transmission rate of maximum 300 Mbps on the downlink and on the order of 75 Mbps on the uplink using a variable band of 1.4 MHz to 20 MHz. In the UMTS networks, systems as successors of LTE are also under study for the purpose of realizing a wider band and higher speed (e.g., LTE Advanced (LTE-A)). For example, LTE-A is scheduled to expand 20 MHz which is a maximum system band of the LTE specification to the order of 100 MHz. Furthermore, the maximum number of transmitting antennas of the LTE specification is scheduled to be expanded from 4 to 8.

Furthermore, for LTE-based systems, a MIMO (Multi Input Multi Output) system is being proposed as a radio communication technique that transmits/receives data through a plurality of antennas and improves a data rate (frequency utilization efficiency) (e.g., see Non-Patent Literature 1). The MIMO system uses a space division multiplexing (SDM) technique that transmits a plurality of different transmission information sequences at the same time and at the same frequency using a plurality of transmitting/receiving antennas. Taking advantage of the fact that different fading fluctuations occur between transmitting and receiving antennas on the receiver side, it is possible to increase the data rate (frequency utilization efficiency) by separating and detecting information sequences which are simultaneously transmitted.

In a cellular systems to which such a MIMO system is applied, it is possible to realize a high transmission capacity through SDM effects for mobile station apparatuses located in central positions of a cell where a signal-to-noise ratio (SNR) is high. However, at cell edges, it is not possible to fully exert SDM effects due to influences of decrease in SNR or increase of interference from other cells. On the other hand, if the number of transmitting/receiving antennas increases, the transmission capacity in SDM can be increased. However, there is a limitation to the number of antennas that can be set up in a base station apparatus or mobile station apparatus and there is also a limitation to increase in the transmission capacity accompanying the increase in the number of antennas.

For LTE-A based systems, as techniques for solving these problems, base station cooperated MIMO whereby base station apparatuses cooperate with each other to perform MIMO transmission and multiuser MIMO which transmits transmission information sequences from different transmitting antennas to different users are being under study. For example, in downlink inter-base-station cooperated multiuser MIMO, a base station apparatus performs block-diagonalization-based precoding based on channel state information (CSI) indicating instantaneous complex fading fluctuation, and can thereby remove (null) interference between mobile station apparatuses

### CITATION LIST

### Non-Patent Literature

Non-Patent Literature 1: 3GPP TR 25.913 “Requirements for Evolved UTRA and Evolved UTRAN”

### SUMMARY OF INVENTION

### Technical Problem

Block-diagonalization-based precoding in downlink inter-base station cooperated multiuser MIMO is realized by respective mobile station apparatuses feeding back CSI to all cooperating base station apparatuses. However, depending on positions of the mobile station apparatuses in a cell, there can be cases where CSI is not fed back to all the cooperating base station apparatuses. When CSI is not fed back to all the cooperating base station apparatuses in this way, interference between mobile station apparatuses is not removed appropriately, resulting in a problem that the transmission capacity is reduced.

The present invention has been implemented in view of such circumstances and it is an object of the present invention to provide an inter-base station cooperated MIMO transmitting method and a base station apparatus that can suppress a decrease in transmission capacity even when channel state information is not fed back from mobile station apparatuses to all cooperating base station apparatuses.

### Solution to Problem

An inter-base station cooperated MIMO transmitting method according to the present invention is an inter-base station cooperated MIMO transmitting method for a plurality of base station apparatuses to cooperate with each other to perform MIMO transmission to a plurality of mobile station apparatuses, the method including a step of acquiring channel state information at the plurality of base station apparatuses from the plurality of mobile station apparatuses, a step of deciding, according to the presence/absence of the channel state information, a cooperation target mobile station apparatus to which the plurality of base station apparatuses cooperate with each other to transmit a signal and a non-cooperation target mobile station apparatus to which a specific base station apparatus transmits a signal, and a step of generating precoding weights for the signals transmitted to the cooperation target and non-cooperation target mobile station apparatuses based on the channel state information.

According to this method, the cooperation target and non-cooperation target mobile station apparatuses are decided according to the presence/absence of channel state information acquired from the mobile station apparatuses, precoding weights for transmission signals addressed to these cooperation target and non-cooperation target mobile station apparatuses are generated based on the channel state information, and it is thereby possible to control the presence/absence of signal transmission to the cooperation target and non-cooperation target mobile station apparatuses and states of interference between these signals, improve the transmission capacity accordingly, and thereby suppress a decrease in the transmission capacity even when channel state information is not fed back to all cooperating base station apparatuses from the mobile station apparatus.

A base station apparatus according to the present invention is a base station apparatus that performs MIMO transmission to a plurality of mobile station apparatuses in cooperation with other base station apparatuses, including a receiving section that receives channel state information from the plurality of mobile station apparatuses, a decision section that decides, according to the presence/absence of the channel state information, a cooperation target mobile station apparatus to which the plurality of base station apparatuses cooperate with each other to transmit a signal and a non-cooperation target mobile station apparatus to which a specific base station apparatus transmits a signal, and a weight generation section that generates precoding weights for the signals transmitted to the cooperation target and non-cooperation target mobile station apparatuses based on the channel state information.

According to this configuration, the cooperation target and non-cooperation target mobile station apparatuses are decided according to the presence/absence of channel state information acquired from the mobile station apparatuses, precoding weights for transmission signals addressed to these cooperation target and non-cooperation target mobile station apparatuses are generated based on channel state information, and it is thereby possible to control the presence/absence of signal transmission to the cooperation target and non-cooperation target mobile station apparatuses and states of interference between signals, improve the transmission capacity accordingly, and thereby suppress a decrease in the transmission capacity even when channel state information is not fed back to all cooperating base station apparatuses from the mobile station apparatus.

### Advantageous Effects of Invention

According to the present invention, it is possible to suppress a decrease in the transmission capacity even when channel state information is not fed back to all cooperating base station apparatuses from the mobile station apparatus.

### BRIEF DESCRIPTION OF DRAWINGS

FIG. 1 is a diagram illustrating a mobile communication system to which an inter-base station cooperated MIMO transmitting method according to an embodiment of the present invention is applied;

FIG. 2 is a block diagram illustrating a configuration of a mobile station apparatus of the mobile communication system according to the above embodiment;

FIG. 3 is a block diagram illustrating a configuration of a base station apparatus of the mobile communication system according to the above embodiment;

FIG. 4 is a diagram illustrating a transmission system model used to compare a transmission capacity of a mobile station apparatus according to the inter-base station cooperated MIMO transmitting method according to the above embodiment with a transmission capacity of a mobile station apparatus according to another transmitting method;

FIG. 5 is a diagram illustrating transmitting methods compared to the inter-base station cooperated MIMO transmitting method according to the above embodiment;

FIG. 6 is a diagram illustrating an average total capacity of each transmitting method when a total capacity is maximized, given certain transmission power;

FIG. 7 is a diagram illustrating an average transmission capacity per mobile station apparatus of each transmitting method when a total capacity is maximized, given certain transmission power;

FIG. 8 is a diagram illustrating a selection probability when a transmitting method is adaptively changed according to a principle of maximizing a total capacity;

FIG. 9 is a diagram illustrating required average total transmission power with respect to Δ of each transmitting method for each mobile station apparatus to obtain a required transmission capacity;

FIG. 10 is a diagram illustrating required average total transmission power per mobile station apparatus of each transmitting method with respect to Δ shown in FIG. 9; and

FIG. 11 is a diagram illustrating a selection probability with respect to Δ when a transmitting method is adaptively changed according to a principle of minimizing required total transmission power.

### DESCRIPTION OF EMBODIMENTS

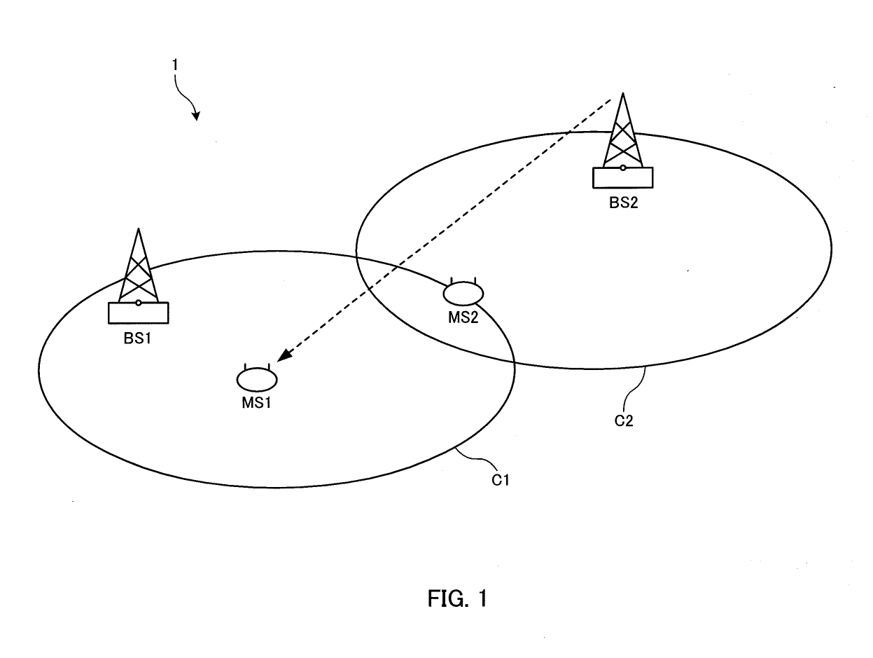

Hereinafter, an embodiment of the present invention will be described in detail with reference to the accompanying drawings. A mobile communication system to which an inter-base station cooperated MIMO transmitting method according to the present invention is applied will be described first. FIG. 1 is a diagram illustrating a mobile communication system to which an inter-base station cooperated MIMO transmitting method according to an embodiment of the present invention is applied. In the mobile communication system shown in FIG. 1, base station apparatuses BS (BS1, BS2) installed in two mutually neighboring cells C (C1, C2) and mobile station apparatuses MS (MS1, MS2) located in the cells C1 and C2 are shown.

In the mobile communication system 1 shown in FIG. 1, the base station apparatus BS1 and the base station apparatus BS2 are configured to be able to cooperate with each other to realize MIMO transmission (inter-base-station cooperated multiuser MIMO transmission) to the mobile station apparatuses MS1 and MS2. The mobile station apparatuses MS1 and MS2 have a function of measuring channel state information (CSI) indicating an instantaneous complex fading fluctuation and feeding back this CSI to the base station apparatuses BS1 and BS2. On the other hand, the base station apparatuses BS1 and BS2 have a function of performing block-diagonalization-based precoding based on the CSI fed back from the mobile station apparatuses MS1 and MS2 and thereby performing information transmission while removing (nulling) interference between the mobile station apparatuses MS1 and MS2.

However, when the distance between the mobile station apparatus MS and the base station apparatus BS is large, there may be a situation in which the mobile station apparatus MS cannot measure the CSI accurately and cannot feed back the CSI to the base station apparatus BS. FIG. 1 shows a case where such a situation occurs between the mobile station apparatus MS1 and the base station apparatus BS2. That is, in FIG. 1, the mobile station apparatus MS1 is located near the base station apparatus BS1 that manages the cell C1 and the distance from the base station apparatus BS2 is quite large. For this reason, it is difficult for the mobile station apparatus MS1 to accurately measure and feed back the CSI. In this case, there may be a situation in which the mobile station apparatus MS1 can feed back average path loss to the base station apparatus BS2, whereas the MS1 cannot feed back the CSI.

In order to apply block-diagonalization-based precoding in such a situation, only the base station apparatus BS1 to which the CSI is fed back accurately may be used to perform information transmission. However, when only the base station apparatus BS1 is used to perform information transmission, the degree of freedom of the MIMO channel decreases and the transmission capacity is extremely reduced compared to the case where information transmission is performed using the base station apparatuses BS1 and BS2. The present inventor came up with the present invention noticing the above-described situation that when CSI is not fed back from some mobile station apparatus MS in inter-base-station cooperated multiuser MIMO, the degree of freedom of a MIMO channel decreases and the transmission capacity decreases.

That is, the inter-base-station cooperated MIMO transmitting method according to the present invention decides a mobile station apparatus MS which is a cooperation target to which a plurality of base station apparatuses BS cooperate with each other to transmit a signal and a mobile station apparatus MS which is a non-cooperation target to which a specific base station apparatus BS transmits a signal according to the presence/absence of CSI fed back from the plurality of mobile station apparatuses MS, and generates precoding weights for transmission signals addressed to these cooperation target and non-cooperation target mobile station apparatuses MS based on the CSI. This makes it possible to control the presence/absence of signal transmission to the cooperation target and non-cooperation target mobile station apparatuses MS and a state of interference between these signals, improve the transmission capacity accordingly, and thereby suppress a decrease in the transmission capacity even when CSI is not fed back from the mobile station apparatus MS to all the cooperating base station apparatuses BS.

To be more specific, by controlling the presence/absence of signal transmission to the cooperation target and non-cooperation target mobile station apparatuses MS and the state of interference between these signals, the method tolerates interference between some mobile station apparatuses MS from which CSI is not fed back, whereas the method removes interference between the mobile station apparatuses MS from which CSI is fed back through block-diagonalization-based precoding (hereinafter referred to as “precoding based on partial non-orthogonal block diagonalization” as appropriate). As described above, this makes it possible to secure the degree of freedom of the MIMO channel compared to a case where information transmission is performed using only the base station apparatus BS1 to which CSI is fed back and suppress a decrease in the transmission capacity.

Hereinafter, an inter-base-station cooperated MIMO transmitting method according to the present invention will be described using an example of arrangement of the base station apparatus BS and the mobile station apparatus MS in the mobile communication system shown in FIG. 1. For the convenience of description, suppose the mobile station apparatus MS1 which is located near the base station apparatus BS1 and can feed back CSI only to the base station apparatus BS1 will be called “in-cell MS” as appropriate and the mobile station apparatus MS2 which is located near a cell edge of the cells C1 and C2 and can feed back CSI to the base station apparatuses BS1 and BS2 will be called “cell edge MS” as appropriate hereinafter. The in-cell MS constitutes the aforementioned non-cooperation target mobile station apparatus MS and the cell edge MS constitutes the aforementioned cooperation target mobile station apparatus MS. One in-cell MS and one cell edge MS are shown in FIG. 1, but these MSs are shown as representatives of a plurality of in-cell MSs and cell edge MSs.

In the mobile communication system shown in FIG. 1, suppose the number of in-cell MSs is “N_{L}” and the number of cell edge MSs is “N_{C}.” Furthermore, suppose the number of transmitting antennas per base station apparatus BS is “Nₜₓ” and the number of receiving antennas per mobile station apparatus MS is “Nᵣₓ.” With such a definition, a channel matrix in the mobile communication system shown in FIG. 1 can be expressed by (Equation 1).

$$H = [ \begin{matrix}{H}_{L , 1}^{( 1 )} & ? \\ {H}_{L , others}^{( 1 )} & ? \\ {H}_{C , 1}^{( 1 )} & {H}_{C , 1}^{( 2 )} \\ {H}_{C , others}^{( 1 )} & {H}_{C , others}^{( 2 )}\end{matrix} ] \qquad ( Equation 1 )$$

Here, a matrix component “?” indicates a portion of CSI that cannot be fed back. Furthermore, “H_{L,1}⁽¹⁾” is a channel matrix of Nᵣₓ×Nₜₓ in size between a first in-cell MS and the base station apparatus BS1 and “H_{L,others}⁽¹⁾” is a channel matrix of (N_{L}−N_{C})Nᵣₓ×Nₜₓ in size between an in-cell MS other than the first in-cell MS and the base station apparatus BS1. Furthermore, “H_{C,1}^{(b)}” is a channel matrix of Nᵣₓ×Nₜₓ in size between a first cell edge MS and a base station apparatus BSb (b=1, 2) and “H_{C,others}^{(b)}” is a channel matrix of (Nc−1)Nᵣₓ×Nₜₓ in size between a cell edge MS other than the first cell edge MS and the base station apparatus BSb (b=1, 2).

For a MIMO channel represented by such channel matrices, the inter-base-station cooperated MIMO transmitting method according to the present invention defines a precoding matrix (precoding weight) based on the following three guidelines.

(1) Interference from the base station apparatus BS2 to the in-cell MS is tolerated.
(2) Interference between mobile station apparatuses MS other than the in-cell MS corresponding to the above guideline (1) is removed through block diagonalization.
(3) Since the base station apparatus BS2 cannot define precoding for the in-cell MSs, signals for the in-cell MSs are transmitted from only the base station apparatus BS1.

A method of generating a precoding matrix for an in-cell MS in the inter-base-station cooperated MIMO transmitting method of the present invention will be described first. Here, a precoding matrix M_{L,1} of 2Nₜₓ×Nᵣₓ in size in the first in-cell MS is defined as shown in (Equation 2).

$${M}_{L , 1} = [ \begin{matrix}{M}_{L , 1}^{( 1 )} \\ {M}_{L , 1}^{( 2 )}\end{matrix} ] \qquad ( Equation 2 )$$

In (Equation 2), “M_{L,1}^{(b)}” is a precoding matrix of Nₜₓ×Nᵣₓ in size used for the first in-cell MS by the base station apparatus BSb (b=1, 2). In this case, according to the inter-base-station cooperated MIMO transmitting method of the present invention, signal transmission is performed to “M_{L,1}⁽²⁾” from only the base station apparatus BS1 (guideline (3)), and therefore (Equation 3) holds true.

M_{L,1}⁽²⁾=0 (Equation 3)

On the other hand, for “ML, 1(1),” since interference between mobile station apparatus MSs other than the in-cell MSs are removed through block diagonalization (guideline 2), it is defined by a null space obtained by singular-value-decomposing “\tilde{H}_{L, 1}⁽¹⁾” shown in (Equation 4).

$${\tilde{H}}_{L , 1}^{( 1 )} = [ \begin{matrix}{H}_{L , others}^{( 1 )} \\ {H}_{C , 1}^{( 1 )} \\ {H}_{C , others}^{( 1 )}\end{matrix} ] \qquad ( Equation 4 )$$

By also applying such processing to other in-cell MSs (not shown in FIG. 1), a precoding matrix for all in-cell MSs is determined. By determining the precoding matrix for all in-cell MSs in this way, it is possible to perform signal transmission from only the base station apparatus BS1 to the in-cell MSs while removing interference with the mobile station apparatus MSs other than these in-cell MSs (that is, cell edge MSs).

Next, a method of generating a precoding matrix for a cell edge MS according to the inter-base-station cooperated MIMO transmitting method of the present invention will be described. Here, a precoding matrix M_{C,1} of 2Nₜₓ×Nᵣₓ in size in the first cell edge MS is defined as shown in (Equation 5).

$${M}_{C , 1} = [ \begin{matrix}{M}_{C , 1}^{( 1 )} \\ {M}_{C , 1}^{( 2 )}\end{matrix} ] \qquad ( Equation 5 )$$

“M_{C, 1}^{(b)}” in (Equation 5) is a precoding matrix of Nₜₓ×Nᵣₓ in size used for the first cell edge MS by the base station apparatus BSb (b=1, 2). In this case, the inter-base-station cooperated MIMO transmitting method of the present invention determines “M_{C, 1}⁽¹⁾” according to guideline (2) such that a transmission signal addressed to the first cell edge MS transmitted from the base station apparatus BS1 does not interfere with the in-cell MS. That is, “M_{C, 1}⁽¹⁾” is determined by a null space obtained by singular-value-decomposing “\tilde{H}_{L, 1}⁽¹⁾” shown in (Equation 6).

$${\tilde{H}}_{C , 1}^{( 1 )} = [ \begin{matrix}{H}_{L , 1}^{( 1 )} \\ {H}_{L , others}^{( 1 )}\end{matrix} ]$$

After “M_{C, 1}⁽¹⁾” is determined based on (Equation 6), “M_{C, 1}⁽²⁾” is determined. The inter-base-station cooperated MIMO transmitting method of the present invention determines “M_{C, 1}⁽²⁾” from (Equation 7) so as to remove interference between cell edge MSs according to (guideline 2).

M_{C,1}⁽²⁾=−(H_{C,others}⁽²⁾)⁻H_{C,others}⁽¹⁾M_{C,1}⁽¹⁾ (Equation 7)

where “(H_{C,others}⁽²⁾)” is Moor Penrose's general inverse matrix of “H_{C,others}⁽²⁾.”

By also applying such processing to other cell edge MSs (not shown in FIG. 1), a precoding matrix for all cell edge MSs is determined. By determining the precoding matrix for all cell edge MSs, it is possible to perform signal transmission to the cell edge MS from the base station apparatuses BS1 and BS2 without causing interference with transmission signals to the in-cell MSs while removing interference between the cell edge MSs.

When a transmission signal is transmitted to the in-cell MS and cell edge MS based on the precoding matrix determined in such a way, although interference occurs from the base station apparatus BS2 to the in-cell MS, since a signal is transmitted from the base station apparatus BS1 to the in-cell MS and signals are transmitted from the base station apparatuses BS1 and BS2 to the cell edge MS, it is possible to secure the degree of freedom of the MIMO channel and suppress a decrease in the transmission capacity compared to the case where information transmission is performed using only the base station apparatus BS1 to which CSI is fed back.

Moreover, when signal transmission is performed from the base station apparatus BS1 to the in-cell MS, interference with the cell edge MS is removed, and when signal transmission is performed from the base station apparatuses BS1 and BS2 to the cell edge MS, interference with the transmission signal to the in-cell MS is avoided and interference between the cell edge MSs is removed. Therefore, it is possible to effectively suppress a decrease in the transmission capacity caused by interference between these transmission signals.

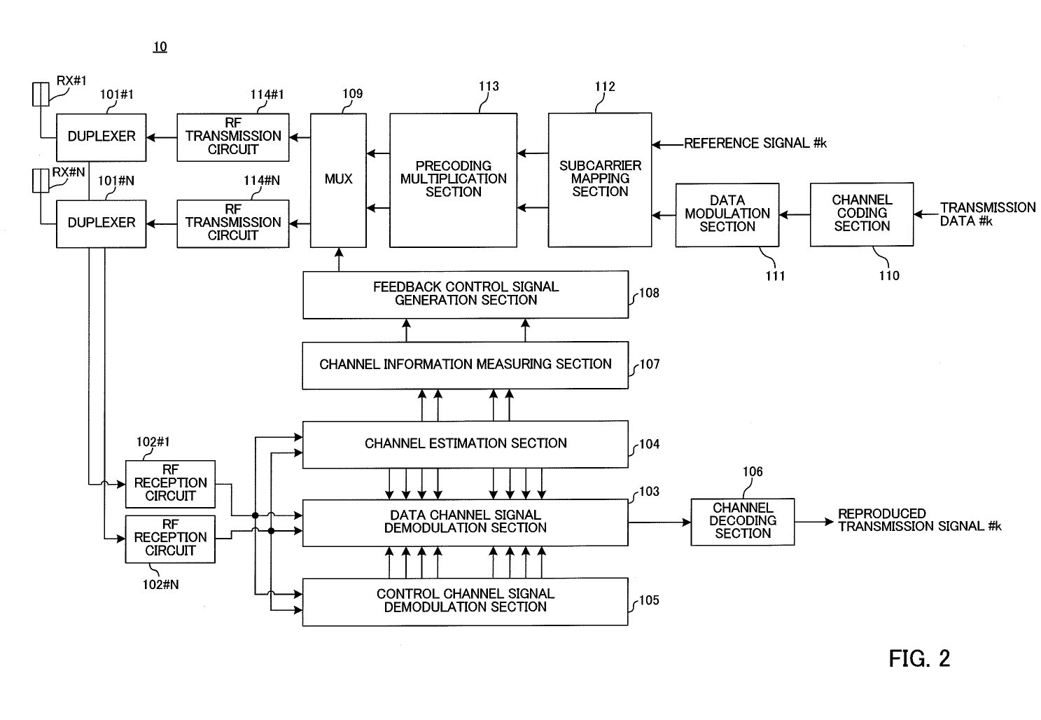

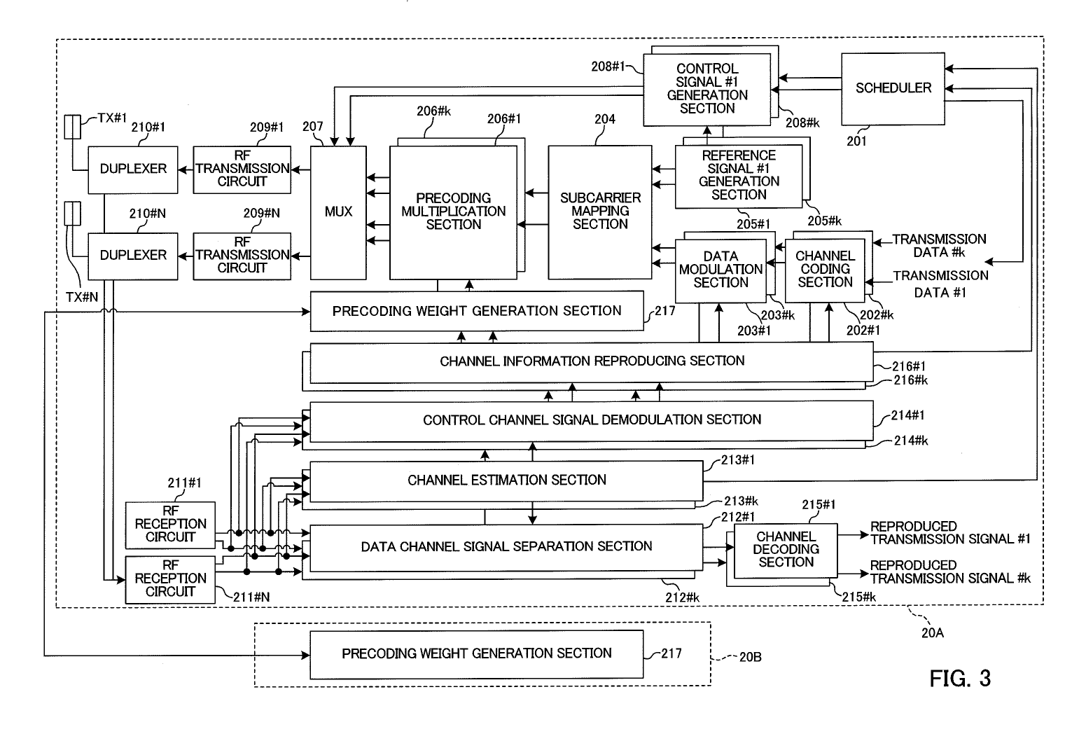

Next, the configurations of a mobile station apparatus (MS) 10 and a base station apparatus (BS) 20 provided for the mobile communication system 1 will be described with reference to FIG. 2 and FIG. 3. FIG. 2 is a block diagram illustrating a configuration of the mobile station apparatus 10 according to the present embodiment. FIG. 3 is a block diagram illustrating a configuration of the base station apparatus 20 according to the present embodiment. The configurations of the mobile station apparatus 10 and the base station apparatus 20 shown in FIG. 2 and FIG. 3 are simplified to illustrate the present invention and are assumed to be provided with components provided for a normal mobile station apparatus and a normal base station apparatus respectively.

First, the configuration of the mobile station apparatus 10 will be described with reference to FIG. 2. The mobile station apparatus 10 shown in FIG. 2 corresponds to the in-cell MS (MS1) or the cell edge MS (MS2) shown in FIG. 1.

In the mobile station apparatus 10 shown in FIG. 2, a transmission signal transmitted from the base station apparatus 20 is received by antennas RX#1 to RX#N, electrically separated by duplexers 101#1 to 101#N into a transmission path and a reception path, and then outputted to RF reception circuits 102#1 to 102#N. The signals are then subjected to frequency conversion processing to be converted from radio frequency signals to baseband signals at RF reception circuits 102#1 to 102#N and subjected to Fourier transform at a fast Fourier transform section (FFT section) (not shown) to be transformed from time series signals to frequency domain signals. The received signals transformed into frequency domain signals are outputted to a data channel signal demodulation section 103.

The data channel signal demodulation section 103 separates the received signals inputted from the FFT section using, for example, a maximum likelihood estimation detection (MLD: Maximum Likelihood Detection) signal separation method. Thus, the received signals arriving from the base station apparatus 20 are separated into received signals relating to user #1 to user #k, and a received signal relating to a user (assumed to be user k, here) of the mobile station apparatus 10 is thereby extracted. A channel estimation section 104 estimates a channel state from a reference signal included in the received signal outputted from the FFT section and reports the estimated channel state to the data channel signal demodulation section 103 and a channel information measuring section 107 which will be described later. The data channel signal demodulation section 103 separates the received signal based on the reported channel state using the aforementioned MLD signal separation method.

A control channel signal demodulation section 105 demodulates a control channel signal (PDCCH) outputted from the FFT section. The control channel signal demodulation section 105 reports control information included in the control channel signal to the data channel signal demodulation section 103. The data channel signal demodulation section 103 demodulates the extracted received signal relating to user k based on the report contents from the control channel signal demodulation section 105. Suppose the extracted received signal relating to user k has been demapped by a subcarrier demapping section (not shown) and returned to a time series signal prior to demodulation processing in the data channel signal demodulation section 103. The received signal relating to user k demodulated in the data channel signal demodulation section 103 is outputted to a channel decoding section 106. The signal is then subjected to channel decoding processing in the channel decoding section 106 and a transmission signal #k is thereby reproduced.

The channel information measuring section 107 measures channel information from the channel state reported from the channel estimation section 104. To be more specific, the channel information measuring section 107 measures CSI based on the channel state reported from the channel estimation section 104 and reports this CSI to a feedback control signal generation section 108. When CSI cannot be measured accurately in relationship with a specific base station apparatus 20, the channel information measuring section 107 reports this fact to the feedback control signal generation section 108. A case will be described here where the fact that CSI cannot be measured accurately is reported from the channel information measuring section 107 of the mobile station apparatus 10, but the processing when CSI cannot be measured is not limited to this. For example, for the base station apparatus 20 that cannot measure CSI, a configuration may be adopted in which the base station apparatus 20 notifies the mobile station apparatus 10 beforehand that CSI should not be measured.

The feedback control signal generation section 108 generates a control signal (e.g., PUCCH) to be fed back to the base station apparatus 20 based on the CSI reported from the channel information measuring section 107. When the feedback control signal generation section 108 receives a report that the CSI has not been successfully measured, the feedback control signal generation section 108 may not feed it back or may generate a control signal to feed back average path loss to the specific base station apparatus 20. The control signal generated in the feedback control signal generation section 108 is outputted to a multiplexer (MUX) 109.

On the other hand, transmission data #k relating to user #k transmitted from a higher layer is channel-coded in a channel coding section 110 and data-modulated in a data modulation section 111. The transmission data #k data-modulated in the data modulation section 111 is subjected to inverse Fourier transform in a discrete Fourier transform section (not shown) to be transformed from a time series signal to a frequency domain signal and outputted to a subcarrier mapping section 112.

The subcarrier mapping section 112 maps the transmission data #k to subcarriers according to schedule information indicated from the base station apparatus 20. In this case, the subcarrier mapping section 112 maps (multiplexes) a reference signal #k generated in a reference signal generation section (not shown) to the subcarriers together with the transmission data #k. In this way, the transmission data #k mapped to the subcarriers is outputted to a precoding multiplication section 113.

The precoding multiplication section 113 makes a phase and/or amplitude shift on the transmission data #k for each of the receiving antennas RX#1 to RX#N based on a precoding weight corresponding to the CSI measured in the channel information measuring section 107. The transmission data #k subjected to the phase and/or amplitude shift in the precoding multiplication section 113 is outputted to the multiplexer (MUX) 109.

The multiplexer (MUX) 109 combines the transmission data #k subjected to the phase and/or amplitude shift with the control signal generated in the feedback control signal generation section 108 to generate a transmission signal for each of the receiving antennas RX#1 to RX#N. The transmission signal generated in the multiplexer (MUX) 109 is subjected to inverse fast Fourier transform in an inverse fast Fourier transform section (not shown) to be transformed from a frequency domain signal to a time domain signal, and then outputted to RF transmission circuits 114#1 to 114#N. The transmission signal is subjected to frequency conversion processing to be converted to a radio frequency band in the RF transmission circuits 114#1 to 114#N, outputted to the antennas RX#1 to RX#N via the duplexers 101#1 to 101#N and transmitted from the receiving antennas RX#1 to RX#N to the base station apparatus 20 over an uplink.

When the mobile station apparatus 10 shown in FIG. 2 is the cell edge MS shown in FIG. 1, control signals containing the measured CSI are transmitted to both base station apparatuses BS1 and BS2. On the other hand, when the mobile station apparatus 10 shown in FIG. 2 is the in-cell MS shown in FIG. 1, a control signal containing the measured CSI is transmitted to the base station apparatus BS1, whereas a control signal containing average path loss is transmitted to the base station apparatus BS2.

Next, the configuration of the base station apparatus 20 will be described with reference to FIG. 3. FIG. 3 shows mutually cooperating base station apparatus 20A and base station apparatus 20B. The base station apparatuses 20A and 20B shown in FIG. 3 correspond to the base station apparatuses BS1 and BS2 shown in FIG. 1 respectively. These base station apparatuses 20A and 20B have common configurations. Therefore, the configuration of the base station apparatus 20A will be described and description of the base station apparatus 20B will be omitted.

In the base station apparatus 20A shown in FIG. 3, a scheduler 201 determines the number of multiplexed users based on channel estimate values supplied from channel estimation sections 213#1 to 213#k and channel state information (CSI) supplied from channel information reproducing sections 216#1 to 216#k which will be described later. The scheduler 201 then determines resource allocation contents (scheduling information) of the uplink and downlink for each user and transmits transmission data #1 to #k corresponding to users #1 to #k to channel coding sections 202#1 to 202#k.

After being channel-coded in the channel coding section 202#1 to 202#k, the transmission data #1 to #k are outputted to data modulation sections 203#1 to 203#k to be data-modulated there. In this case, the channel coding and data modulation are performed based on channel coding rates and modulation schemes supplied from the channel information reproducing sections 216#1 to 216#k. The transmission data #1 to #k data-modulated in the data modulation sections 203#1 to 203#k are subjected to inverse Fourier transform in a discrete Fourier transform section (not shown) to be transformed from time series signals to frequency domain signals and outputted to a subcarrier mapping section 204.

Reference signal generation sections 205#1 to 205#k generate specific reference signals (UE specific RS) for data channel demodulation for users #1 to user #k. The specific reference signals generated in the reference signal generation sections 205#1 to 205#k are outputted to the subcarrier mapping section 204.

The subcarrier mapping section 204 maps the transmission data #1 to #k to subcarriers according to the schedule information supplied from the scheduler 201. The transmission data #1 to #k mapped to the subcarriers in this way are outputted to precoding multiplication sections 206#1 to 206#k.

The precoding multiplication sections 206#1 to 206#k make a phase and/or amplitude shift on the transmission data #1 to #k for each of antennas TX#1 to #N based on precoding weights supplied from a precoding weight generation section 217 (weighting of the antennas TX#1 to #N through precoding). The transmission data #1 to #k subjected to the phase and/or amplitude shift in the precoding multiplication sections 206#1 to 206#k are outputted to a multiplexer (MUX) 207.

Control signal generation sections 208#1 to 208#k generate control signals (PDCCHs) based on the number of multiplexed users from the scheduler 201. The respective PDCCHs generated in the control signal generation sections 208#1 to 208#k are outputted to the multiplexer (MUX) 207.

The multiplexer (MUX) 207 combines the transmission data #1 to #k subjected to the phase and/or amplitude shift with the respective PDCCHs generated in the control signal generation sections 208#1 to 208#k to generate a transmission signal for each of the transmitting antennas TX#1 to TX#N. The transmission signals generated in the multiplexer (MUX) 207 are subjected to inverse fast Fourier transform in an inverse fast Fourier transform section (not shown) to be transformed from frequency domain signals to time domain signals and then outputted to RF transmission circuits 209#1 to 209#N. After being subjected to frequency conversion processing to be converted to a radio frequency band in the RF transmission circuits 209#1 to 209#N, the transmission signals are outputted to the transmitting antennas TX#1 to TX#N via duplexers 210#1 to 210#N and transmitted from the antennas TX#1 to #N to the mobile station apparatus 10 over a downlink.

On the other hand, transmission signals transmitted from the mobile station apparatus 10 over an uplink are received in the antennas TX#1 to #N, electrically separated into a transmission path and a reception path in the duplexers 210#1 to 210#N, and then outputted to RF reception circuits 211#1 to 211#N. After being subjected to frequency conversion processing to be converted from radio frequency signals to baseband signals in the RF reception circuits 211#1 to 211#N, the received signals are subjected to Fourier transform in a fast Fourier transform section (FFT section) (not shown) to be transformed from time series signals to frequency domain signals. The received signals transformed into frequency domain signals are outputted to data channel signal separation sections 212#1 to 212#k.

The data channel signal separation sections 212#1 to 212#k separate the received signals inputted from the FFT section using, for example, a maximum likelihood estimation detection (MLD) signal separation method. This causes a received signal arriving from the mobile station apparatus 10 to be separated into received signals relating to user #1 to user #k. Channel estimation sections 213#1 to 213#k estimate channel states from reference signals contained in the received signals outputted from the FFT section and report the estimated channel states to the data channel signal separation sections 212#1 to 212#k and control channel signal demodulation sections 214#1 to 214#k. The data channel signal separation sections 212#1 to 212#k separate the received signals based on the reported channel states using the aforementioned MLD signal separation method.

The received signals relating to user #1 to user #k separated by the data channel signal separation sections 212#1 to 212#k are demapped in a subcarrier demapping section (not shown), returned to time series signals and data-demodulated in a data demodulation section (not shown). The received signals are then subjected to channel decoding processing in channel decoding sections 215#1 to 215#k, and transmission signal #1 to transmission signal #k are thereby reproduced.

The control channel signal demodulation sections 214#1 to 214#k demodulate control channel signals (e.g., PDCCHs) contained in the received signals inputted from the FFT section. In this case, the control channel signal demodulation sections 214#1 to 214#k demodulate control channel signals corresponding to user #1 to user #k. In this case, the control channel signal demodulation sections 214#1 to 214#k demodulate the control channel signals based on the channel states reported from the channel estimation sections 213#1 to 213#k. The respective control channel signals demodulated in the control channel signal demodulation sections 214#1 to 214#k are outputted to the channel information reproducing sections 216#1 to 216#k.

The channel information reproducing sections 216#1 to 216#k reproduce channel-related information (channel information) from information contained in the respective control channel signals (e.g., PUCCHs) inputted from the control channel signal demodulation sections 214#1 to 214#k. The channel information contains feedback information such as CSI reported through PDCCH, for example. The CSI reproduced by the channel information reproducing sections 216#1 to 216#k is outputted to the precoding weight generation section 217 and the scheduler 201. The channel coding rates and modulation schemes identified based on this CSI are outputted to the data modulation sections 203#1 to 203#k, and channel coding sections 202#1 to 202#k respectively. The reception sequence including the channel information reproducing section 216 that processes a control channel signal containing feedback information such as CSI constitutes a receiving section that receives channel state information from a plurality of mobile station apparatuses 10.

The precoding weight generation section 217 generates a precoding weight indicating an amount of phase and/or amplitude shift corresponding to the transmission data #1 to #k based on the CSI or weight information inputted from the channel information reproducing sections 216#1 to 216#k, CSI inputted from the precoding weight generation section 217 of the cooperating base station apparatus 20B. The respective precoding weights generated in the precoding weight generation section 217 are outputted to the precoding multiplication section 206#1 to 206#k and used for precoding of the transmission data #1 to transmission data #k.

In this case, the precoding weight generation section 217 generates precoding weights (determines a precoding matrix) according to the aforementioned guidelines (1) to (3). To be more specific, according to the presence/absence of CSI, the precoding weight generation section 217 decides a mobile station apparatus 10 which is a cell edge MS and to which the base station apparatus 20A transmits a signal in cooperation with the other base station apparatus 20B and a mobile station apparatus 10 which is an in-cell MS and to which the specific base station apparatus 20 transmits a signal. The precoding weight generation section 217 generates a precoding weight for the mobile station apparatus 10 which is the in-cell MS to remove interference between this mobile station apparatus 10 and the mobile station apparatus 10 other than the in-cell MS, and on the other hand generates a precoding weight for the mobile station apparatus 10 which is the cell edge MS to remove interference between the mobile station apparatuses 10 which are the cell edge MSs without causing interference with the mobile station apparatus 10 which is the in-cell MS.

This precoding weight generation section 217 constitutes a decision section that decides a cell edge MS and in-cell MS according to the presence/absence of CSI and also constitutes a weight generation section that generates precoding weights for transmission signals addressed to the cell edge MS and in-cell MS.

Similarly, based on the CSI inputted from the channel information reproducing sections 216#1 to 216#k and the CSI inputted from the precoding weight generation section 217 of the base station apparatus 20A, the precoding weight generation section 217 of the base station apparatus 20B generates a precoding weight for the mobile station apparatus 10 which is the in-cell MS to remove interference between this in-cell MS and the mobile station apparatus 10 other than the in-cell MS, and on the other hand, generates a precoding weight for the mobile station apparatus 10 which is cell edge MS to remove interference between the mobile station apparatuses 10 which are the cell edge MSs without causing interference with the mobile station apparatus 10 which is the in-cell MS.

Thus, the base station apparatuses 20A and 20B share CSI arriving from the mobile station apparatus 10, generate desired precoding weights corresponding to the transmission data #1 to #k based on such CSI, and it is thereby possible to perform signal transmission to the mobile station apparatus 10 which is the in-cell MS from only the base station apparatus 20A (BS1) while removing interference between the mobile station apparatus 10 which is the in-cell MS and the mobile station apparatus 10 other than the in-cell MS. On the other hand, it is possible to perform signal transmission to the mobile station apparatus 10 which is the cell edge MS from the base station apparatus 20A (BS1) and the base station apparatus 20B (BS2) without causing interference with the mobile station apparatus 10 which is the in-cell MS and while removing interference between the mobile station apparatuses 10 which are the cell edge MSs. As a result, although interference occurs from this base station apparatus BS2 to the in-cell MS, a signal is transmitted to the in-cell MS from the base station apparatus BS1 and signals are transmitted to the cell edge MS from the base station apparatuses BS1 and BS2, and it is thereby possible to secure the degree of freedom of the MIMO channel and suppress a decrease in the transmission capacity compared to the case where information transmission is performed using only the base station apparatus BS1 to which CSI is fed back.

### Embodiment

Next, a result of comparison between the transmission capacity of the mobile station apparatus MS (in-cell MS, cell edge MS) using the inter-base-station cooperated MIMO transmitting method according to the present embodiment and the transmission capacity of the mobile station apparatus MS (in-cell MS, cell edge MS) using another transmitting method will be described. For convenience of description, an example of the mobile station apparatus MS (in-cell MS, cell edge MS) and the base station apparatus BS (BS1, BS2) shown in FIG. 1 will be described below. Equivalent channel matrices “B_{L, 1}” and “B_{C, 1}” containing precoding matrices for the first in-cell MS and the first cell edge MS determined as described above are expressed by (Equation 8) and (Equation 9) respectively.

B_{L,1}=H_{L,1}⁽¹⁾M_{L,1}⁽¹⁾ (Equation 8)

B_{C,1}=H_{C,1}⁽¹⁾M_{C,1}⁽¹⁾+H_{C,1}⁽²⁾M_{C,1}⁽²⁾ (Equation 9)

In this case, when “λ_{C, 1, |}” and “p_{C, 1, |}” (1≦|≦Nᵣₓ) are assumed to be a singular value and allocated power of a first stream of an equivalent channel matrix B_{C, 1} in the first cell edge MS respectively, the transmission capacity of the cell edge MS is expressed by (Equation 10).

$${C}_{C , 1} = {\sum }_{l = 1}^{{N}_{rx}} {log}_{2} ( 1 + \frac{{\vert {λ}_{C , 1 , l} \vert}^{2} {p}_{C , 1 , l}}{{N}_{0}} ) ( b \text{/} s \text{/} Hz ) \qquad ( Equation 10 )$$

where “N₀” denotes noise power. Thus, since the transmission capacity C_{C, 1} of the cell edge MS is not affected by interference or the like, the base station apparatus 20 can accurately estimate the transmission capacity based on (Equation 10).

On the other hand, the base station apparatus 20 cannot accurately estimate the transmission capacity of the in-cell MS due to influences of interference. However, if “λ_{C, 1, |}” and “p_{C, 1, |}” (1≦|≦Nᵣₓ) are assumed to be a singular value and allocated power of a first stream of an equivalent channel matrix B_{L, 1} in the first in-cell MS respectively, the transmission capacity of the in-cell MS is estimated by (Equation 11).

$${\overline{C}}_{L , 1} = {\sum }_{l = 1}^{{N}_{rx}} {log}_{2} ( 1 + \frac{{\vert {λ}_{L , 1 , l} \vert}^{2} {p}_{L , 1 , l}}{{G}_{L , 1}^{( 2 )} {P}_{C}^{( 2 )} + {N}_{0}} ) ( b \text{/} s \text{/} Hz ) \qquad ( Equation 11 )$$

where “G_{L, 1}⁽²⁾” denotes average path loss between the base station apparatus BS2 and the first in-cell MS and “P_{C}⁽²⁾” denotes total transmission power from the base station apparatus BS2 to all cell edge MSs.

In the comparison result shown below, power allocation was performed based on a water filling principle using (Equation 10) and (Equation 11). (Equation 10) was used only when applying the water filling principle to the base station apparatus BS and the actual transmission capacity of the in-cell MS was measured accurately using a channel matrix between the in-cell MS and the base station apparatus BS.

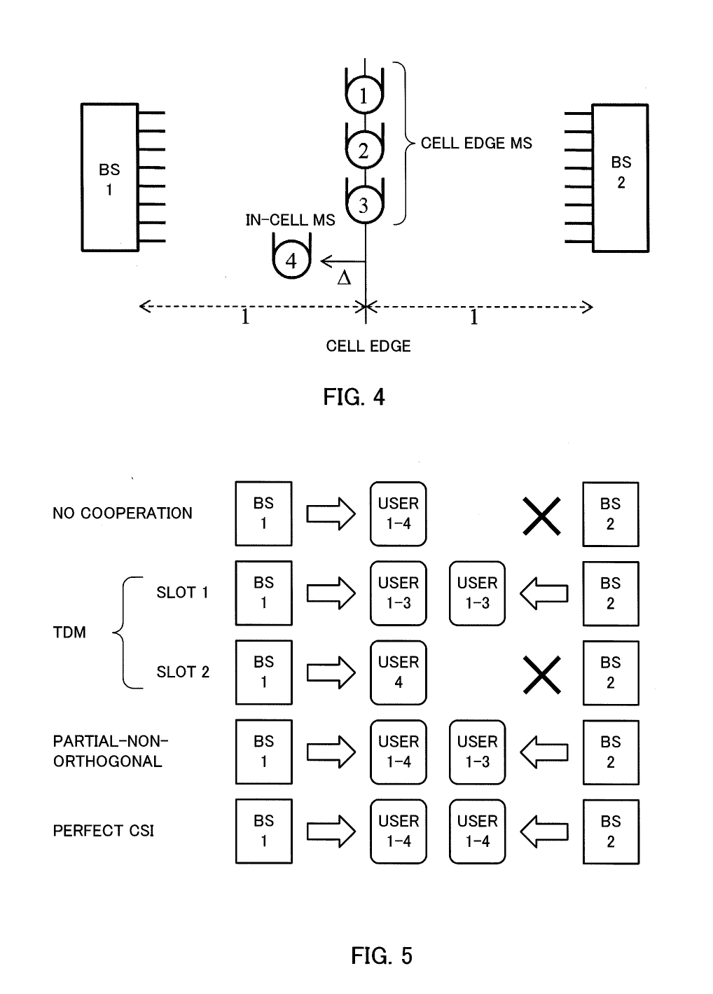

FIG. 4 is a diagram illustrating a transmission system model used to compare the transmission capacity of the mobile station apparatus MS using the inter-base-station cooperated MIMO transmitting method according to the present embodiment and the transmission capacity of the mobile station apparatus MS using another transmitting method. In the transmission system model shown in FIG. 4, suppose the number of in-cell MSs is 1 and the number of cell edge MSs is 3. Furthermore, suppose the number of transmitting antennas is 8 and the number of receiving antennas is 2. Furthermore, the cell edge MSs are fixed at cell edges located at equal distances from the base station apparatus BSs and the in-cell MS is located at a position shifted by Δ in a direction closer to the base station apparatus BS1. For Δ, a value normalized by the cell radius is used. Furthermore, distance attenuation based on the law of the −3.76th power of the distance is assumed to be an average path loss. Furthermore, independent Rayleigh fluctuations are assumed as fading among all transmitting/receiving antennas. Furthermore, the transmission power is normalized with such a value that an average SNR (Signal-to-Noise Ratio) becomes 0 dB at the cell edge during one-antenna transmission/reception.

Here, a comparison is made between the inter-base-station cooperated MIMO transmitting method according to the present invention (hereinafter referred to as “non-orthogonal SDM” as appropriate) and three other transmitting methods shown in FIG. 5.

(1) Not cooperated (no cooperation): In this case, MIMO transmission using block diagonalization is performed on all mobile station apparatus MSs always using only the base station apparatus BS1.
(2) TDM (Time Division Multiplexing): In this case, in a first time slot, cooperated MIMO transmission using block diagonalization is performed on all cell edge MSs from both base station apparatuses BS1 and BS2. In a second time slot, MIMO transmission using block diagonalization is performed on all in-cell MSs from only the base station apparatus BS1. Therefore, transmission is performed to all mobile station apparatuses MS between two time slots as in the case of other transmitting methods.
(3) Non-orthogonal SDM (Partial non-orthogonal): In this case, transmission is always performed to all mobile station apparatuses MS from both base station apparatuses BS1 and BS2 using precoding based on the aforementioned partial non-orthogonal block diagonalization.

Suppose the channel state is constant within the two time slots and changes independently between the two time slots. Furthermore, in addition to the aforementioned three transmitting methods, inter-base-station cooperated multiuser MIMO transmission (Perfect CSI shown in FIG. 5) applying block diagonalization was also evaluated together in the case where CSI of all mobile station apparatuses MS were completely fed back.

Furthermore, characteristics when the aforementioned three transmitting methods were adaptively switched according to the channel state were also evaluated. As the principle of switching between the transmitting methods, a principle of maximizing the total capacity, given certain transmission power, and a principle of minimizing required total transmission power for each mobile station apparatus MS to acquire the required transmission capacity were used.

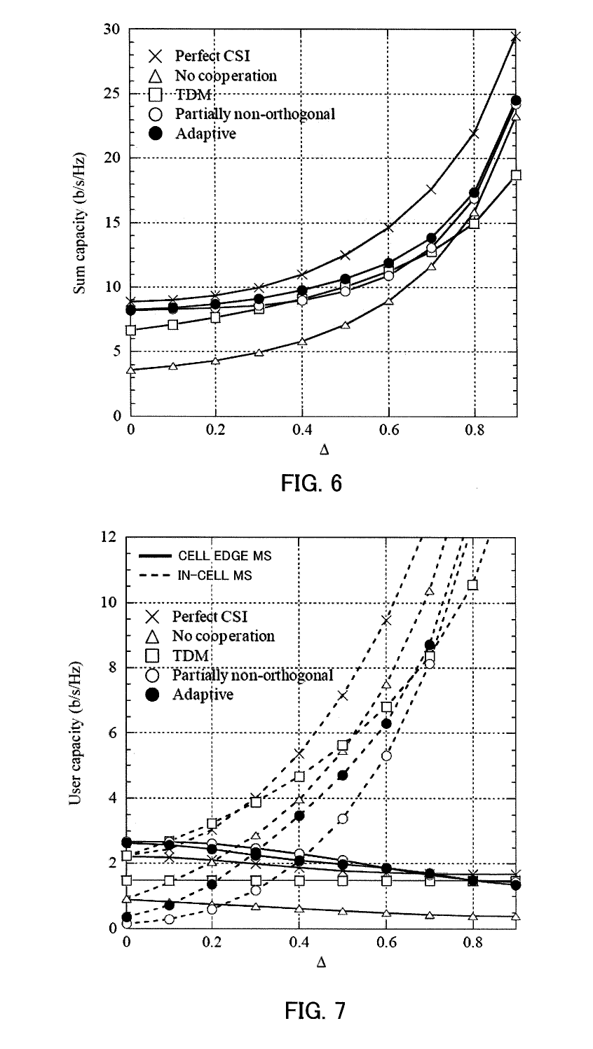

The comparison results of the respective transmitting methods when maximizing the total capacity, given certain transmission power will be described first. FIG. 6 shows an average total capacity with respect to Δ using each transmitting method and FIG. 7 shows an average transmission capacity per mobile station apparatus MS with respect to Δ using each transmitting method in this case. The transmission power is indicated using such a value that an average SNR becomes 0 dB at the cell edge during one-antenna transmission/reception. It is observed that the total capacity with no cooperation deteriorates compared to all the other transmitting methods. This is attributable to a decrease in the degree of freedom of the MIMO channel resulting from no cooperation among the base station apparatuses BS. The total capacity of non-orthogonal SDM can be increased compared to that of TDM when Δ is smaller than 0.4 and greater than 0.6.

The reason will be examined using FIG. 7. As shown in FIG. 7, in the case of TDM, the transmission capacity of the cell edge MS is constant irrespective of the value of Δ, whereas the transmission capacity of the cell edge MS of non-orthogonal SDM is the maximum among the four transmitting methods in the region where Δ is small. This is because in non-orthogonal SDM, the degree of freedom of the MIMO channel increases due to tolerance to interference with the in-cell MS and a maximum diversity gain is thereby obtained. The transmission capacity of the cell edge MS deteriorates as Δ increases because the transmission power allocated to the cell edge MS decreases.

On the other hand, the transmission capacity of the in-cell MS in non-orthogonal SDM deteriorates compared to that of TDM when Δ is small. This is because a transmission signal addressed to the cell edge MS from the base station apparatus BS2 constitutes interference with the in-cell MS and this causes the transmission quality of the in-cell MS to deteriorate. However, the transmission capacity of the in-cell MS increases as Δ increases in non-orthogonal SDM compared to TDM. This is because a signal is transmitted to the in-cell MS using one time slot in the case of TDM, whereas signals are always transmitted to all mobile station apparatuses MS in the case of non-orthogonal SDM, and interference between MSs from the cell edge MS to the in-cell MS is sufficiently suppressed in non-orthogonal SDM due to an increase in path loss between the base station apparatus BS2 and the in-cell MS. As a result, when Δ is small, the diversity gain by the cell edge MS in non-orthogonal SDM is greater than in TDM, and therefore the total capacity increases. On the other hand, when Δ is sufficiently large, deterioration of the transmission capacity of the in-cell MS due to interference between the mobile station apparatuses MS is reduced due to an increase in path loss, which may cause the total capacity to increase.

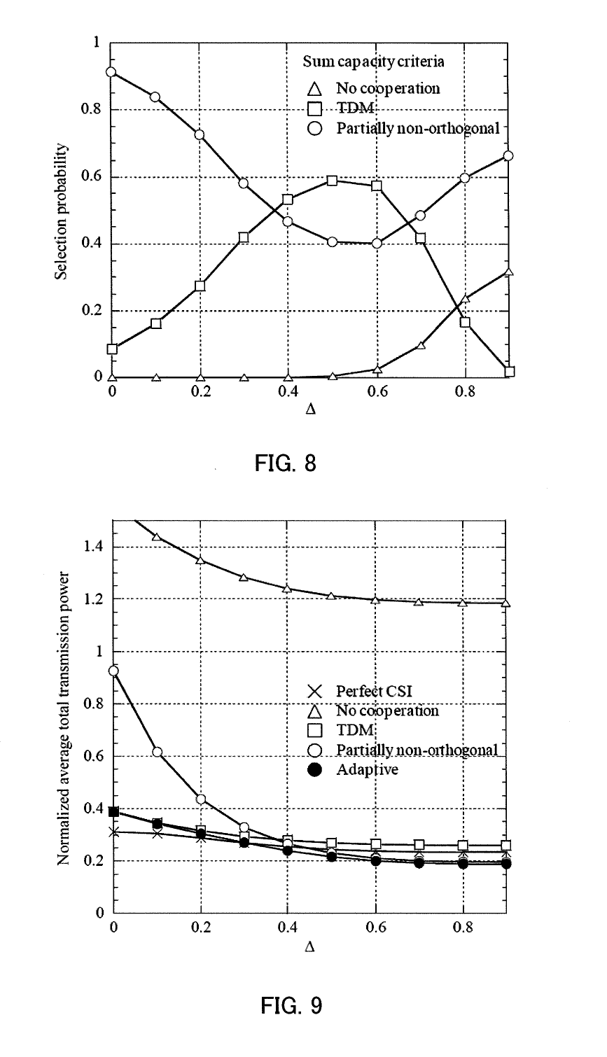

Furthermore, when Δ is 0.2 to 0.8, a further increase in the transmission capacity is observed due to adaptive switching between transmitting methods. This is because non-orthogonal SDM and TDM achieve a relatively comparative degree of average total capacity within this range, and therefore diversity between transmission schemes functions by switching between transmitting methods according to an instantaneous channel state. FIG. 8 illustrates a selection probability with respect to Δ when the transmitting method is adaptively switched according to a principle of maximizing the total capacity. It can be confirmed from FIG. 8 that when Δ is 0.3 to 0.7, the selection probability in non-orthogonal SDM is at a level comparable to that in TDM.

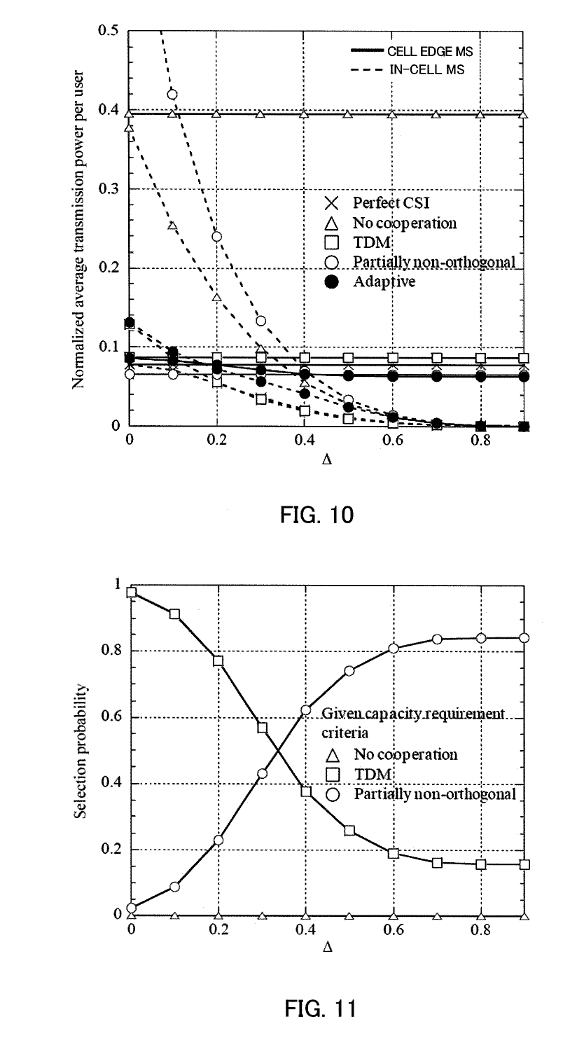

Next, a comparison is made in required average total transmission power for each mobile station apparatus MS to acquire a transmission capacity. Assuming that the required transmission capacity is common to all mobile station apparatuses MS and is set to 1 b/s/Hz. FIG. 9 shows required average total transmission power with respect to Δ according to each transmitting method and FIG. 10 shows required average total transmission power per mobile station apparatus MS with respect to Δ according to each transmitting method in this case. Required transmission power with no cooperation increases drastically compared to the other transmitting methods. This is because the degree of freedom of the MIMO channel decreases when the base station apparatuses BS do not cooperate with each other. Required transmission power in non-orthogonal SDM increases when Δ is smaller than 0.4 compared to TDM. This is because the required transmission power of the in-cell MS increases due to interference from the cell edge MS to the in-cell MS. This is obvious when a region where Δ is small in FIG. 10 is observed.

However, when Δ increases, required total transmission power can be reduced in non-orthogonal SDM compared to TDM. This is because the degree of freedom of the MIMO channel increases due to tolerance to interference with the in-cell MS in non-orthogonal SDM, and thus a maximum diversity can be obtained. For this reason, as shown in FIG. 10, required transmission power of the cell edge MS can be reduced. Furthermore, when Δ increases, required transmission power of the in-cell MS can be reduced drastically in non-orthogonal SDM. This is because due to an increase in path loss between the base station apparatus BS2 and the in-cell MS, interference between the mobile station apparatuses MS from the cell edge MS to the in-cell MS can be suppressed sufficiently in non-orthogonal SDM. That is, as Δ increases, suppression of interference between the mobile station apparatuses MS which are in-cell MSs due to increases in the diversity gain and path loss with respect to the cell edge MS allows the required total transmission power in non-orthogonal SDM to be more effectively reduced than TDM. Furthermore, when Δ is greater than 0.4, it is possible to reduce required total transmission power in non-orthogonal SDM more than the transmitting method using block diagonalization when perfect CSI is provided. This is because non-orthogonal SDM reduces constraints on interference between mobile station apparatuses MS compared to block diagonalization when perfect CSI is provided. That is, this is because the degree of freedom of selecting precoding increases so that the received signal power increases.

FIG. 11 shows a selection probability with respect to Δ when adaptively switching between the transmitting methods according to a principle of minimizing required total transmission power. It is clear from FIG. 11 that when Δ is greater than 0.35, the selection probability in non-orthogonal SDM becomes maximum among the three transmitting methods. Since there can actually be a case where instantaneous CSI cannot be fed back when Δ is large, non-orthogonal SDM can be said to be a useful transmitting method in a realistic situation.

As described above, in the inter-base-station cooperated MIMO transmitting method according to the present embodiment, interference between mobile station apparatuses MS whose CSI is partially unknown is tolerated and interference between other mobile station apparatuses MS is removed (nulled) using block diagonalization, and the degree of freedom of the MIMO channel is thereby increased. Based on the aforementioned comparison result, the inter-base-station cooperated MIMO transmitting method according to the present embodiment can more effectively use the degree of freedom of the MIMO channel, and can thereby improve the system performance compared to the case where perfect orthogonality is secured. Since there can actually be a case where instantaneous CSI cannot be fed back when Δ is large, this is an extremely useful transmitting method.

The present invention has been described in detail using the aforementioned embodiment, but it is obvious to those skilled in the art that the present invention is not limited to the embodiment described in the present DESCRIPTION. The present invention can be implemented as modified or altered embodiments without departing from the spirit and scope of the present invention defined in the scope of patent claims. Therefore, the description of the present DESCRIPTION is meant to be illustrative, and by no means meant to have any limitative meaning to the present invention.

For example, although a case has been described in the above embodiment where the precoding weight generation sections 217 of both base station apparatuses 20A and 20B generate precoding weights with respect to the in-cell MS and cell edge MS, the configuration of the base station apparatus 20 is not limited to this, but can be modified as appropriate. For example, a specific base station apparatus 20 (e.g., base station apparatus 20A) may be provided with a function of generating precoding weights so that the specific base station apparatus 20 generates precoding weights for the other base station apparatuses 20 (e.g., base station apparatus 20B) and reports the precoding weights.

The present application is based on Japanese Patent Application No. 2010-132353 filed on Jun. 9, 2010, entire content of which is expressly incorporated by reference herein.

1. An inter-base station cooperated MIMO transmitting method for a plurality of base station apparatuses to cooperate with each other to perform MIMO transmission to a plurality of mobile station apparatuses, the method comprising:
a step of acquiring channel state information at the plurality of base station apparatuses from the plurality of mobile station apparatuses;
a step of deciding, according to the presence/absence of the channel state information, a cooperation target mobile station apparatus to which the plurality of base station apparatuses cooperate with each other to transmit a signal and a non-cooperation target mobile station apparatus to which a specific base station apparatus transmits a signal; and
a step of generating precoding weights for the signals transmitted to the cooperation target and non-cooperation target mobile station apparatuses based on the channel state information.

2. The inter-base-station cooperated MIMO transmitting method according to claim 1, wherein, as a precoding weight for the signal transmitted to the non-cooperation target mobile station apparatus, the precoding weight is generated to remove interference with the signal transmitted to the cooperation target mobile station apparatus as well as to transmit a signal from only the specific base station apparatus to the non-cooperation target mobile station apparatus.

3. The inter-base-station cooperated MIMO transmitting method according to claim 2, wherein the interference with the signal transmitted to the cooperation target mobile station apparatus is removed through block diagonalization.

4. The inter-base-station cooperated MIMO transmitting method according to claim 2, wherein, as a precoding weight for the signal transmitted to the cooperation target mobile station apparatus, the precoding weight is generated to remove interference between signals transmitted to the cooperation target mobile station apparatus from a base station apparatus other than the specific base station apparatus as well as to remove interference with the signal transmitted from the specific base station apparatus to the non-cooperation target mobile station apparatus.

5. The inter-base-station cooperated MIMO transmitting method according to claim 4, wherein the interference with the signal transmitted to the non-cooperation target mobile station apparatus is removed through block diagonalization and the interference between signals transmitted to the cooperation target mobile station apparatus is removed by using Moore Penrose's inverse matrix.

6. The inter-base-station cooperated MIMO transmitting method according to claim 1, wherein deciding a mobile station apparatus that feeds back the channel state information to all the plurality of base station apparatuses as the cooperation target mobile station apparatus and deciding a mobile station apparatus that feeds back the channel state information to only the specific base station apparatus as the non-cooperation target mobile station apparatus.

7. A base station apparatus that performs MIMO transmission to a plurality of mobile station apparatuses in cooperation with other base station apparatuses, comprising:
a receiving section that receives channel state information from the plurality of mobile station apparatuses;
a decision section that decides, according to the presence/absence of the channel state information, a cooperation target mobile station apparatus to which the plurality of base station apparatuses cooperate with each other to transmit a signal and a non-cooperation target mobile station apparatus to which a specific base station apparatus transmits a signal; and
a weight generation section that generates precoding weights for the signals transmitted to the cooperation target and non-cooperation target mobile station apparatuses based on the channel state information.

8. The base station apparatus according to claim 7, wherein the weight generation section generates, as a precoding weight for the signal transmitted to the non-cooperation target mobile station apparatus, the precoding weight for removing interference with the signal transmitted to the cooperation target mobile station apparatus as well as for transmitting a signal from only the specific base station apparatus to the non-cooperation target mobile station apparatus.

9. The base station apparatus according to claim 7, wherein the weight generation section generates, as a precoding weight for the signal transmitted to the cooperation target mobile station apparatus, the precoding weight for removing interference between signals transmitted to the cooperation target mobile station apparatus from a base station apparatus other than the specific base station apparatus as well as for removing interference with the signal transmitted from the specific base station apparatus to the cooperation target mobile station apparatus.
